(19) United States
(12) Patent Application Publication
(10) Pub. No.: US 2003/0070909 A1
(43) Pub. Date: Apr. 17, 2003

(54) Tactile keyboard for electrical appliances and equipment

(76) Inventor: Michael J. Sullivan, Barrington Hills, IL (US)

Correspondence Address: Edward D. Gilhooly, Suite 423, 28 East jackson blvd., Chicago, IL, 60604, US

(21) Appl. No.: 10/173,961

(22) Filed: Jun. 18, 2002

Related U.S. Application Data
(60) Provisional application No. 60/298,420, filed on Jun. 18, 2001.

(51) Int. Cl. H01H 13/70

(52) U.S. Cl. 200/512

(57) ABSTRACT

A tactile keyboard having a plurality of raised separate domed keys capability of being distinguished from each other by touch with the keys being mounted on the upper surface of a polycarbonate layer. The domed keys are formed from a compressible plastic, such as urethane, and form clear lenses to view indicia associated with each of the domed keys. The shape of the domed keys on the polycarbonate surface at their base are defined by ink barriers printed on the surface.

This application claims benefit of the filing date of provisional application, serial No. 60/298,420 filed Jun. 18, 2001.

### BACKGROUND OF THE INVENTION

1. Field of the Invention

This invention relates in general to the control of electrical equipment and appliances and more particularly, to an improved tactile keypad.

2. Summary of the Prior Art

Keyboards and pads have long been used to provide codes and data for the operation of numerous kinds of electrical equipment and appliances used by individuals in travel, in the household, and in industry. The first known keypads were often depressible keys to transmit codes and data to equipment and appliances for numerous purposes for such purposes of operation, transmitting information, and other utilitarian tasks. In recent years depressible membranes and the like have served as keypads in a number of applications. There are several deficiencies in prior designs normally used. Many are expensive to manufacture and fail to provide an optimum lifetime of service. Such expensive techniques include a board made up of injection molded keys.

Moreover, in known keyboards, some individual key positions in the key array are not provided with suitable delineation to permit convenient tactile positioning in use which is particularly advantageous to the individual when operating the device. This is particularly a problem where differential between individual keys is difficult because an indication of what key is being depressed is not evident. Other problems in the prior art arise because of the failure to provide optimum three-dimensionality for improved feel.

Further, in using polycarbonate films in the keyboard as known as present, current techniques for manufacturing keyboard require relatively expensive and requires uneconomical steps of fabrication. The limits of service of a membrane switch as previously described can be seen after a membrane switch is activated even a few thousand times under which conditions considerable wear on the polycarbonate occurs. Therefore, it is desirable in the prior art to provide a keyboard having optimum three-dimensional domed keys having improved feel, visual distinctiveness, and economy of manufacture with a device exceeding the service capability of more expensive designs.

In some situations, if a clear window were needed on the base of the keypad, a printer with prior techniques would need to start with an untextured polycarbonate. But if a textured surface were also wanted on the keyboard, then the printer in the past would print a textured surface, which increases production costs. In addition, the printer must also apply a hard coat or scratch resistant coating to one of or both surfaces of the polycarbonate layer, also adding an expensive manufacturing step.

### SUMMARY OF THE INVENTION

It is therefore an objective of the invention to provide an improved keyboard pad having one or more three-dimensional keys demonstrating a soft feel and a three dimensional configuration. The keys are formed from urethane contained on the surface of a surface of polycarbonate sheet. The urethane forms separate soft dome keys creating a transparent lens to cover indicia printed on the polycarbonate which, when compressed, activate respective membrane switches in an electrical control circuit. The use of a plurality of keys in the keyboard of the invention more positively delineates the position of each key by feel as compared to flat keys in the prior art. The invention allows for a gloss and matte surface to be combined on a velvet polycarbonate for enhanced appearance.

Further, the keys of the invention provide clear, see-through lens to make a base textured, surface to be as clear as a acrylic or smooth clear polycarbonate material. The use of an actual textured polycarbonate base material herein disclosed increases wear resistance and durability for sustained cycles of use. Moreover, the invention of the application eliminates the necessity of texturing the polycarbonate layer and rendering it scratch resistant as in the prior art.

### BRIEF DESCRIPTION OF THE DRAWINGS

FIG. 1 is a top plan view of one embodiment of the tactile keyboard of the invention:

FIG. 2 is an end elevational view, with parts in section, of the keyboard of the invention taken along lines 2-2 of Fig.;

FIG. 3 is a top plan view of a second embodiment of the keyboard of the invention: and FIG. 4 is an end elevational view, with parts in section, of the keyboard of the invention taken along lines 4-4 of FIG. 3.

### DESCRIPTION OF THE PREFERRED EMBODIMENTS

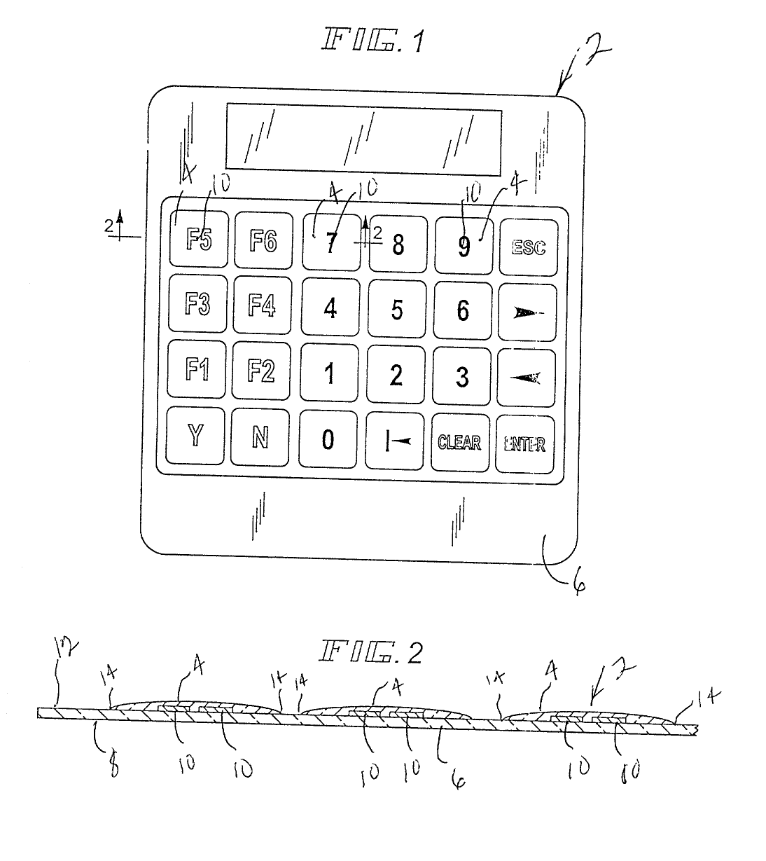

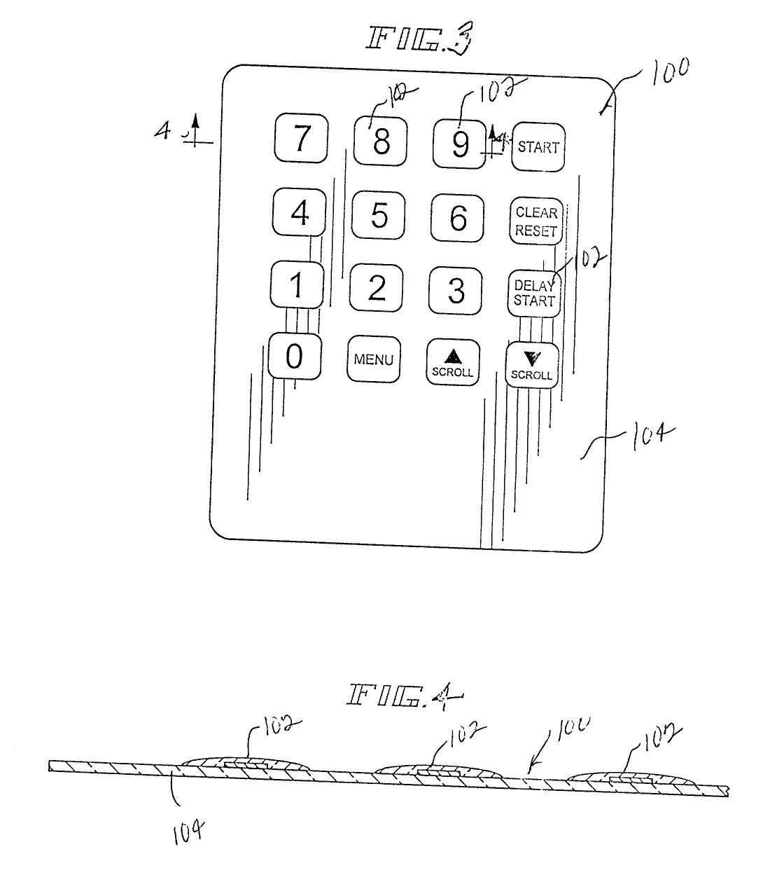

Referring now to FIGS. 1 and 2, there is illustrated a first embodiment of the tactile keyboard or pad of the invention, generally designated by reference numeral 2. The keyboard 2 includes a plurality of three dimensional, soft tactile keys 4 representing a predetermined function or command for use in an electrical circuit or equipment (not shown). The keys 4 are arranged to be manually compressed to actuate an adjacent respective membrane switch and the like (not shown) of conventional design each associated with each of the plurality of keys 4. The raised domed keys 4 may be arranged in any geometric pattern and are tactilely separate and distinct from each other.

The keys 4 are attached to a thin layer 6 of polycarbonate, such as sold under the trademark LEXAN by General Electric, which layer 6 is mounted on a substrate 8 by a conventional technique. The layer 6 is generally clear when supplied and possesses a velvet texture which does not require a texturing process or scratch resistant process as in the prior art. One of the surfaces 8 may have colors printed on it. The thickness of the polycarbonate layer 6 may be 0.010 inches, although other thickness may be used

The individual keys 4 form transparent lenses from a flowable urethane plastic, which hardens into a soft compressible material to actuate a respective membrane switch (not shown) that is mounted in a conventional manner beneath the keyboard 2. The transparent keys 4 provide a view of indicia 10 in the form of numbers, words, letters, icons, and the like that are printed on surface 12 of the polycarbonate layer 6 or on a surface of the substrate 8. In the manufacture of the keys 4 when being applied to polycarbonate layer 6, an ink barrier 14 is printed on an area of surface 12 to outline the periphery and base shape of each individual key 4, such as, for example, generally square cross section as shown in plan view in FIG. 1. Other plan shapes of keys 4 can be used if desirable. The ink barrier 14 may be an ink material sold under the trademark FLOWSTOP by Development Associates in North Kingston, R.I. The ink barrier 14 is printed on surface 12 and creates a surface delineation by altering the physical properties of surface 12 to prevent the flow of urethane past the periphery outline created by barrier 14 when the urethane is poured by injection molding during the assemble process in a flowable state within the outline printed by the barrier ink 14. Thus, flowable urethane is applied during the manufacture process at each of the selected positions of the plurality of keys 4. After hardening soft flexible state, the urethane material creates a clear lens to allow the user to view the indicia 12 beneath the keys 4. Colors may be applied to the reversed surface of the layer 6. The use of polycarbonate layer 6 eliminates the expensive need for texturing the surface in a simulated manner as in the prior art. The individual keys 4 are operated by compressing the keys 4 in any given sequence as required. As seen in FIG. 1, the keys 4 are formed in a raised domed shaped for clear delineation of each key by the user. The keys 4 also provide a soft tactile touch for the convenience and comfort of the user. The raised shape of the keys and soft touch are far more comfortable and user friendly than prior art flat keypads. As seen in FIG. 1, the keypad 2 includes a transparent window to display information to the user. The surface 12 may also be colored around the keys.

Referring to FIGS. 3 and 4, there is illustrated a second embodiment of the tactile keypad of the invention generally designated by reference numeral 100. The keypad 100 is generally identical to the keypad 2 previously described with reference to FIGS. 1 and 2. The keypad 100 includes a plurality of soft, domed keys 102 mounted on polycarbonate layer 104 such as sold under the trademark LEXAN. The keys 102 are formed in the same manner as previously described from a flowable urethane.

The tactile keyboard herein disclosed may be used to control and operate control electrical circuits of appliances, communication equipment, machinery, security devices, computer equipment, machinery and the like in which the circuits are con trolled by external manual inputs.

What is claimed is:

1. A tactile keyboard for providing inputs to electrical devices if electrical circuits comprising
a flat member having an upper surface,
said flat member having raised key means affixed to said upper surface,
said raised key means forming at least one raised key of deformable plastic material and being in operative relation to the electrical device,
said raised key being manually compressible to activate the electrical device,
said at least one raised key forming a lens for viewing said upper surface, and
indicia means being affixed to said flat member in visual position beneath said at least one raised key.

2. The tactile keyboard according to claim 1 wherein said raised key means include a plurality of raised domed keys affixed to said upper surface, said domed keys being spaced apart from each other.

3. The tactile keyboard according to claim 1 further including barriers applied to said upper surface beneath a respective domed key, said barrier being applied to said upper surface to define the periphery of said domed key, said barrier preventing the flow of plastic material in a flowable state beyond said periphery to form each of said plurality of domed keys.

4. The tactile keyboard according to claim 3 wherein said raised dome is formed from a flowable urethane in a heated state that hardens into a compressible soft hardened state.

5. The tactile keyboard according to claim 3 wherein said barrier is a barrier ink printed on said upper surface.

6. The tactile keyboard according to claim 3 wherein said upper surface is formed by a polycarbonate.

7. The tactile keyboard according to claim 3 wherein said sheet of polycarbonate is a flat sheet attached to a substrate.

8. The tactile keyboard according to claim 7 wherein said layer of polycarbonate is 0.10 inches thick.

9. The tactile keyboard according to claim 7 wherein said sheet of polycarbonate possesses a velvet texture.
